(19) United States
(12) Patent Application Publication
(10) Pub. No.: US 2019/0093000 A1
(43) Pub. Date: Mar. 28, 2019

(54) SELF-SUSPENDING MATERILAL FOR DIVERSION APPLICATIONS

(71) Applicant: Halliburton Energy Services, Inc., Houston, TX (US)

(72) Inventors: Snehalata S. Agashe, Houston, TX (US); Mahesh Vijaykumar Biyani, Houston, TX (US); Shoy George Chittattukara, Houston, TX (US); Larry Steven Eoff, Porter, TX (US)

(73) Assignee: Halliburton Energy Services, Inc., Houston, TX (US)

(21) Appl. No.: 16/090,750

(22) PCT Filed: Jun. 9, 2016
(86) PCT No.: PCT/US16/36765

§ 371 Date: Oct. 2, 2018

(51) Int. Cl. C09K 8/514; C09K 8/504; E21B 33/138; E21B 37/00; E21B 43/26; E21B 21/00

(52) U.S. Cl. CPC C09K 8/514; C09K 8/5045; E21B 33/138; E21B 37/00; E21B 43/267; E21B 21/003; C09K 2208/04; C09K 2208/26; E21B 43/26

(57) ABSTRACT

A method of servicing a wellbore in a subterranean formation including combining diverter material and aqueous base fluid to form a diverter fluid, wherein the diverter material is self-suspending and comprises psyllium husk particulates; introducing the diverter fluid into the wellbore; and allowing the diverter material to form a diverter plug in the wellbore or the formation. A method of servicing a wellbore in a subterranean formation including combining diverter material including psyllium husk particulates and a first wellbore servicing fluid; introducing the first wellbore servicing fluid into the wellbore; allowing the diverter material to form a diverter plug in a first location in the wellbore or the formation; diverting the flow of a second wellbore servicing fluid to a second location in the wellbore of formation; and removing the diverter plug, wherein the first and second wellbore servicing fluids may be the same or different.

### BACKGROUND

The present invention generally relates to the use of diversion materials in subterranean operations, and, more specifically, to self-suspending diversion fluid systems, and methods of using these diversion fluid systems in subterranean operations.

Natural resources (e.g., oil or gas) residing in the subterranean formation may be recovered by driving resources from the formation into the wellbore using, for example, a pressure gradient that exists between the formation and the wellbore, the force of gravity, displacement of the resources from the formation using a pump or the force of another fluid injected into the well or an adjacent well. The production of fluid in the formation may be increased by hydraulically fracturing the formation. That is, a viscous fracturing fluid may be pumped down the wellbore at a rate and a pressure sufficient to form fractures that extend into the formation, providing additional pathways through which the oil or gas can flow to the well.

Unfortunately, water rather than oil or gas may eventually be produced by the formation through the fractures therein. To provide for the production of more oil or gas, a fracturing fluid may again be pumped into the formation to form additional fractures therein. However, the previously used fractures first must be plugged to prevent the loss of the fracturing fluid into the formation via those fractures.

Diversion is essential in acidizing treatments as well as hydraulic fracturing treatments to push the treatment fluid into untreated zones. Ineffective diversion can lead to poor zonal coverage, formation damage and increase in costs of completions.

Traditional fracturing operations, also termed plug and perforate operations, to increase the productivity of the subterranean formation, employ a perforation of the subterranean formation followed by setting of a fracturing plug with typical operation times ranging from 3-5 hours. Additionally to achieve a user and/or process desired goal, the fracturing may need to be repeated numerous times resulting in lengthy equipment stand by times. Once the process is complete the fracturing plugs are typically removed, for example by drilling out. Alternative methods employ processes utilizing perforation in conjunction with degradable diverting materials. These processes have a disadvantage in that the degradable diverting materials utilized need to be removed prior to production. Some attempts to overcome this problem include adding a degradation accelerator to the diverting materials. An ongoing need exists for improved compositions and methods for diverting operations.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIG. 1 depicts an embodiment of a system configured for delivering the diverter fluid systems of the embodiments described herein to a downhole location.

FIG. 2 is a graph of fluid loss vs time in a static HPHT test utilizing diverter fluids according to the disclosure.

FIG. 3 is a graph of fluid loss vs time in a static HPHT test utilizing diverter fluids according to the disclosure plus a control fluid.

FIG. 4 is a graph of fluid loss vs time in a static HPHT test utilizing a control fluid.

### DETAILED DESCRIPTION

Embodiments of the invention are directed to treatment fluids including self-suspending diversion materials comprising psyllium husks and to methods for treating subterranean wells with the treatment fluid.

Psyllium Husk

The treatment methods and fluids of the disclosure include psyllium husk. Psyllium husk (Plantago Ovata husk) comes from a variety of plants belonging to the Plantago genus. These plants are cultivated mainly in India, as well as in Europe and a small amount in the United States. The psyllium husk is produced by separating it from the seed by application of mechanical pressure to crack the coat, followed by boiling water and mechanical gravity separation to remove the husk. Unlike gelling agent powders, psyllium husk is a fibrous kind of material husk, they are the fibrous hulls of the psyllium seed. However, these fibers have a coating of mucilage which hydrates when placed in brine. The fibrous-like part remains intact within the hydrated mucilage. Small particles of the hard fibrous portion help in bridging through small pore throats in a formation leading to fluid loss control. Further, no external breaker is required to dissolve formed filter cakes because these fibrous parts eventually degrade after few hours under downhole conditions.

The psyllium husk used for methods and fluids disclosed is obtained in the form of fibrous powder, and may be processed by gelling it before it is added into treatment fluids. The psyllium husk may have a particle size of about 1 micron 1 micron to about 5000 microns (about 0.001 mm to about 5 mm) when dissolved in water. In certain cases, the particle size may be smaller or larger than about 1 to about 5000 microns. In other examples, the particle size may be from about 1, 10, 25, 50, 75, 100, 150, or 200 microns to about 200, 500, 1000, 2000, 3000, 4000, or 5000 microns. In some instances, the particle size distribution for the psyllium husk may be: D(0.1) of about 1 μM to about 500 μM; D(0.5) of about 100 μM to about 1000 μM; and D(0.9) of about 200 μM to about 5000 μM. Alternatively, the particle size distribution of the psyllium husk may be: D(0.1) of about 1 μM to about 10 μM; D(0.5) of about 50 μM to about 100 μM; and D(0.9) of about 200 μM to about 400 μM.

In an embodiment, the self-suspending diverter materials may be present in a wellbore servicing fluid in an amount of from about 0.01 pounds per gallon (ppg) (1.2 lb/m³) to about 6 ppg (720 lb/m³), alternatively from about 0.1 ppg (1.2 lb/m³) to about 2 ppg (240 lb/m³), or alternatively from about 0.1 ppg (1.2 lb/m³) to about 1 ppg (120 lb/m³). The diverter fluid may be present in an amount of about 40 ppt (4.8 kg/m³) to about 80 ppt (9.6 kg/m³) by volume of diverter fluid.

General Measurement Terms

Unless otherwise specified or unless the context otherwise clearly requires, any ratio or percentage means by volume.

If there is any difference between U.S. or Imperial units, U.S. units are intended.

Unless otherwise specified, mesh sizes are in U.S. Standard Mesh.

The micrometer (μm) may sometimes be referred to herein as a micron.

The conversion between pound per gallon (lb/gal or ppg) and kilogram per cubic meter (kg/m³) is: 1 lb/gal=(1 lb/gal)×(0.4536 kg/lb)×(gal/0.003785 m³)=120 kg/m³.

1 pound per thousand gallons (“ppt”) is 0.120 kg/m³.

In an embodiment, a method of servicing a wellbore in a subterranean formation comprises: combining diverter material and aqueous base fluid to form a diverter fluid, wherein the diverter material is self-suspending and comprises psyllium husk particulates; introducing the diverter fluid into the wellbore; and allowing the diverter material to form a diverter plug in the wellbore or the formation. The method may further comprise allowing the diverter material to degrade to provide a pathway from the formation to the wellbore for recovery of resources from the subterranean formation. The degrading may or may not include breakers. The degrading may occur in a wellbore or formation with an essentially neutral pH. The diverter material may degrade at least about 50% within 6 hours at about 180° F. (82° C.). The method may not comprise using a gelling agent. The combining may further comprise adding an internal breaker. The internal breaker may comprise at least one breaker selected from the group consisting of an acid, an oxidizer, an enzyme, and combinations thereof. The combining may further comprise adding a bridging agent. The diverter material may be present in the diverter fluid in the amount of from about 40 ppt (4.8 kg/m³) to about 80 ppt (9.6 kg/m³) by volume of diverter fluid.

In an embodiment, method of servicing a wellbore in a subterranean formation comprises: combining diverter material and a first wellbore servicing fluid, wherein the diverter material is self-suspending and comprises psyllium husk particulates and the first wellbore servicing fluid comprises an aqueous base fluid; introducing the first wellbore servicing fluid into the wellbore; allowing the diverter material to form a diverter plug in a first location in the wellbore or the formation; diverting the flow of a second wellbore servicing fluid to a second location in the wellbore of formation; and removing the diverter plug, wherein the first and second wellbore servicing fluids may be the same or different. The removing may not include breakers. The removing may occur in a wellbore or formation with an essentially neutral pH. The diverter material may degrade at least about 50% within 6 hours at about 180° F. (82° C.). The diverter material and first wellbore servicing fluid may not comprise using a gelling agent. The combining may further comprise adding an internal breaker. The internal breaker may comprise at least one breaker selected from the group consisting of an acid, an oxidizer, an enzyme, and combinations thereof. The combining may further comprise adding a bridging agent. The diverter material may be present in the first wellbore servicing fluid in the amount of from about 40 ppt (4.8 kg/m³) to about 80 ppt (9.6 kg/m³) by volume of diverter fluid. The first wellbore servicing fluid may comprise a diverting fluid and the second wellbore servicing fluid may comprise a fracturing fluid.

In an embodiment, a method of servicing a wellbore in a subterranean formation comprises: placing a wellbore fluid into a subterranean formation at a first location; plugging the first location with a self-suspending diverter material comprising psyllium husk particulates, wherein all or a portion of the wellbore servicing fluid is diverted to a second location in the subterranean formation; placing the wellbore servicing fluid into the subterranean formation at the second location; and allowing the diverter material to degrade to provide a flowpath from the subterranean formation to the wellbore for recovery of resources from the subterranean formation. The degrading may not include breakers. The degrading may occur in a wellbore or formation with an essentially neutral pH. The diverter material may degrade at least about 50% within 6 hours at about 180° F. (82° C.). The method may not comprise using a gelling agent. The plugging may further comprise adding an internal breaker. The internal breaker may comprise at least one breaker selected from the group consisting of an acid, an oxidizer, an enzyme, and combinations thereof. The plugging may further comprise adding a bridging agent. The plugging may include a diverter material in the wellbore servicing fluid in the amount of from about 40 ppt (4.8 kg/m³) to about 80 ppt (9.6 kg/m³) by volume of diverter fluid.

In an embodiment, a wellbore treatment fluid comprises a diverter material and an aqueous base fluid, wherein the diverter material is self-suspending and comprises psyllium husk particulates. The degrading may or may not include breakers. The diverter material may degrade at least about 50% within 6 hours at about 180° F. (82° C.). The fluid may not comprise a gelling agent. The fluid may further comprise an internal breaker. The internal breaker may comprise at least one breaker selected from the group consisting of an acid, an oxidizer, an enzyme, and combinations thereof. The fluid may further comprise a bridging agent. The diverter material may be present in the diverter fluid in the amount of from about 40 ppt (4.8 kg/m³) to about 80 ppt (9.6 kg/m³) by volume of diverter fluid.

In an exemplary embodiment, a well treatment system comprises a well treatment apparatus, including a mixer and a pump, configured to: combine diverter material and aqueous base fluid to form a diverter fluid, wherein the diverter material is self-suspending and comprises psyllium husk particulates; introduce the diverter fluid into the wellbore; and allow the diverter material to form a diverter plug in the wellbore or the formation. The system may not include a gelling agent. The system may further comprise an internal breaker combined with the diverter material.

Aqueous Base Fluids

The aqueous base fluid of the present embodiments can generally be from any source, provided that the fluids do not contain components that might adversely affect the stability and/or performance of the treatment fluids of the present invention. In various embodiments, the aqueous base fluid can comprise fresh water, salt water, seawater, brine, or an aqueous salt solution. In some embodiments, the aqueous base fluid can comprise a monovalent brine or a divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like.

The treatment fluid is preferably a water-based fluid wherein the aqueous base phase of the fluid is greater than 50% by weight water. Typically, the water is present in the treatment fluids in an amount at least sufficient to substantially hydrate the diverter material and any optional viscosity-increasing agent. In some examples, the aqueous phase, including the dissolved materials therein, may be present in the treatment fluids in an amount in the range from about 5% to 100% by volume of the treatment fluid.

In some embodiments, the aqueous base fluid is present in the diverter treatment fluids in the amount of from about 20% to about 99% by volume of the fluid system.

Internal Breakers

The methods and fluids of the disclosure may contain an optional internal breaker. The internal breaker may comprise, for example, a breaker selected from the group consisting of an acid, an oxidizer (such as a peroxide, a persulfate, a perborate, an oxyacid of a halogen, an oxyanion of a halogen, chlorous acid, hypochlorous acid), an enzyme, and combinations thereof. Likewise, the breaker may comprise, for example, a breaker selected from the group consisting of formic acid, tert-butyl hydrogen peroxide, ferric chloride, magnesium peroxide, magnesium peroxydiphosphate, strontium peroxide, barium peroxide, calcium peroxide, magnesium perborate, barium bromate, sodium chlorite, sodium bromate, sodium persulfate, sodium peroxydisulfate, ammonium chlorite, ammonium bromate, ammonium persulfate, ammonium peroxydisulfate, potassium chlorite, potassium bromate, potassium persulfate, potassium peroxydisulfate, one or more oxidizable metal ions (i.e., a metal ion whose oxidation state can be increased by the removal of an electron, such as copper, cobalt, iron, manganese, vanadium), and mixtures thereof.

In some examples, the treatment fluids of the present disclosure comprise a solid internal breaker. For example, the solid internal breaker maybe a metal oxide, such as magnesium peroxide. The amount of solid internal breaker may vary depending on need, but can be in an amount from about 0.25 to about 10 lbs. per thousand gal. (0.03 to about 1.2 kb/m³) of the well treatment fluid. In some instances, the amount of solid internal breaker may be less than or greater than this range. Likewise, the amount of solid internal breaker may be in an amount from about 0.1, 0.25, 0.5, 0.75, 1.0, 1.5, 3.0, or 4.0 to about 5.0, 6.0, 7.0, 7.5, 8.0, 9.0, or 10 lbs per thousand gal. (0.012, 0.03, 0.06, 0.09, 0.12, 0.18, 0.36, 0.48 to about 0.6, 0.72, 0.84, 0.9, 0.96, 1.08, 1.2 kg/m³) of the treatment fluid.

In some examples, the treatment fluid comprises both a liquid internal breaker and a solid internal breaker. For instance, the liquid internal breaker may be selected from the group consisting of formic acid, tiertiary butyl hydrogen peroxide, and a combination thereof. If a solid internal breaker is also present, it may be, for example, a metal oxide, such as magnesium oxide.

The amount of liquid internal breaker may vary depending on need, but can be in an amount from about 0.25 to about 10 gal. per thousand gal. (0.03 to about 1.2 kb/m³) of the treatment fluid. In some instances, the amount of liquid internal breaker may be less than or greater than this range. Likewise, the amount of liquid internal breaker may be in an amount from about 0.1, 0.25, 0.5, 0.75, 1.0, 1.5, 3.0, or 4.0 to about 5.0, 6.0, 7.0, 7.5, 8.0, 9.0, or 10 gal. per thousand gal. (0.012, 0.03, 0.06, 0.09, 0.12, 0.18, 0.36, 0.48 to about 0.6, 0.72, 0.84, 0.9, 0.96, 1.08, 1.2 kg/m³) of the treatment fluid.

In some examples, the treatment fluid further comprises a breaker activator. For example, the breaker activator may be a metal selected from the group consisting of chromium, copper, manganese, cobalt, nickel, iron, and vanadium. More specifically, in some examples, the breaker activator may be selected from the group consisting of vanadium acetyl acetonate, ferric chloride, and manganese acetyl acetonate. In some cases, the breaker activator is ferric chloride.

External Breakers

The methods of the disclosure may optionally use an external breaker. After an aqueous well treatment fluid is placed where desired in the well and for the desired time, the fluid usually must be removed from the wellbore or the formation. For example, in the case of hydraulic fracturing, the fluid should be removed leaving the proppant in the fracture and without damaging the conductivity of the proppant bed. To accomplish this removal, the viscosity of the treatment fluid may be reduced to a very low viscosity, preferably near the viscosity of water, for optimal removal from the propped fracture. Similarly, when a viscosified fluid is used for gravel packing, the viscosified fluid may be removed from the gravel pack.

Reducing the viscosity of a viscosified treatment fluid is referred to as “breaking” the fluid. Chemicals used to reduce the viscosity of well fluids are called breakers. No particular mechanism is necessarily implied by the term. For example, a breaker can reduce the molecular weight of a water-soluble polymer by cutting the long polymer chain. As the length of the polymer chain is cut, the viscosity of the fluid is reduced. For instance, reducing the guar polymer molecular weight to shorter chains having a molecular weight of about 10,000 converts the fluid to near water-thin viscosity. This process can occur independently of any crosslinking bonds existing between polymer chains.

For example, the breaker may be a peroxide with oxygen-oxygen single bonds in the molecular structure. These peroxide breakers may be hydrogen peroxide or other material such as a metal peroxide that provides peroxide or hydrogen peroxide for reaction in solution. A peroxide breaker may be a so-called stabilized peroxide breaker in which hydrogen peroxide is bound or inhibited by another compound or molecule(s) prior to its addition to water but is released into solution when added to water.

Examples of suitable stabilized peroxide breakers include the adducts of hydrogen peroxide with other molecules, and may include carbamide peroxide or urea peroxide (CH₄N₂OH₂O₂), percarbonates, such as sodium percarbonate (2Na₂CO₃.H₂O₂), potassium percarbonate and ammonium percarbonate. The stabilized peroxide breakers may also include those compounds that undergo hydrolysis in water to release hydrogen peroxide, such sodium perborate. A stabilized peroxide breaker may be an encapsulated peroxide. The encapsulation material may be a polymer that can degrade over a period of time to release the breaker and may be chosen depending on the release rate desired. Degradation of the polymer can occur, for example, by hydrolysis, solvolysis, melting, or other mechanisms. The polymers may be selected from homopolymers and copolymers of glycolate and lactate, polycarbonates, polyanhydrides, polyorthoesters, and polyphosphacenes. The encapsulated peroxides may be encapsulated hydrogen peroxide, encapsulated metal peroxides, such as sodium peroxide, calcium peroxide, zinc peroxide, etc. or any of the peroxides described herein that are encapsulated in an appropriate material to inhibit or reduce reaction of the peroxide prior to its addition to water.

The peroxide breaker, stabilized or unstabilized, is used in an amount sufficient to break the cross-linking. Lower temperatures may require greater amounts of the breaker. In many, if not most applications, the peroxide breaker may be used in an amount of from about 0.001% to about 20% by weight of the treatment fluid, more particularly from about 0.005% to about 5% by weight of the treatment fluid, and more particularly from about 0.01% to about 2% by weight of the treatment fluid.

Additional examples of breakers include: ammonium, sodium or potassium persulfate; sodium peroxide; sodium chlorite; sodium, lithium or calcium hypochlorite; bromates; perborates; permanganates; chlorinated lime; potassium perphosphate; magnesiummonoperoxyphthalate hexahydrate; and a number of organic chlorine derivatives such as N,N′-dichlorodimethylhydantoin and N-chlorocyanuric acid and/or salts thereof. The specific breaker employed may depend on the temperature to which the fracturing fluid is subjected. At temperatures ranging from about 50° C. to about 95° C., an inorganic breaker or oxidizing agent, such as, for example, KBrO₃, and other similar materials, such as KClO₃, KIO₃, perborates, persulfates, permanganates (for example, ammonium persulfate, sodium persulfate, and potassium persulfate) and the like, are used to control degradation of the fracturing fluid. At about 90 to 95° C. and above, typical breakers such sodium bromate, may be used.

Breaking aids or catalysts may be used with the peroxide breaker. The breaker aid may be an iron-containing breaking aid that acts as a catalyst. The iron catalyst is a ferrous iron (II) compound. Examples of suitable iron (II) compounds include, but are not limited to, iron (II) sulfate and its hydrates (such as, for example, ferrous sulfate heptahydrate), iron (II) chloride, and iron (II) gluconate. Iron powder in combination with a pH adjusting agent that provides an acidic pH may also be used. Other transition metal ions can also be used as the breaking aid or catalyst, such as manganese (Mn).

Magnesium Peroxide is an oxidizer which slowly decomposes to release oxygen. Since magnesium peroxide is a powdered solid, it becomes an integral part of the filter cake. Due to the extremely low solubility of magnesium peroxides it remains stable for extended periods of time in alkaline environment and within the filter cake. The magnesium peroxide, when exposed to an acidic solution, it releases hydrogen peroxide which degrades the polysaccharide type polymers and open-up the external filter cake.

pH and pH Adjusters

Typically, the pH of the treatment fluid is in the range of about 1 to about 10. In acidizing treatments, the pH is often less than about 4.5. In certain examples, the treatment fluids can include a pH-adjuster. The pH-adjuster may be present in the treatment fluids in an amount sufficient to maintain or adjust the pH of the fluid. In some examples, the pH-adjuster may be present in an amount sufficient to maintain or adjust the pH of the fluid to a pH in the range of from about 1 to about 4 at the time of introducing into the well.

In general, one of ordinary skill in the art, with the benefit of this disclosure, will recognize the appropriate pH-adjuster and amount thereof to use for a chosen application. It should be understood that if the treatment fluid includes a degradable polymer, as the polymer degrades, it may release acid. For example, a polylactide may degrade to release lactic acid, which may lower the pH in situ.

The treatment fluids of the present disclosure also may comprise a pH adjusting agent. The pH adjusting agents may be included in the fluid to facilitate the formation of the crosslinking. In certain examples in which the pH is to be increased, suitable pH adjusting agents may comprise a base. Examples of suitable bases include, but are not limited to, sodium hydroxide, potassium hydroxide, lithium hydroxide, sodium carbonate, potassium carbonate, ammonium hydroxide or a combination thereof. Typically, an appropriate pH for forming and maintaining the crosslinked fracturing fluid of the present disclosure is at least 7, or ranges from about 7 to about 12, about 7.5 to about 10, or about 8 to about 10.

In other examples in which the pH is to be decreased, suitable pH adjusting agents comprise an acid. For example, the acid may be fumaric acid, formic acid, acetic acid, acetic anhydride, hydrochloric acid, hydrofluoric acid, hydroxyfluoroboric acid, polyaspartic acid, polysuccinimide, or a combination thereof. The appropriate pH adjusting agent and amount used may depend on the formation characteristics and conditions, on the breaking or crosslinking time desired, on the nature of the cationic cellulose, and on other factors known to individuals skilled in the art with the benefit of this disclosure.

The treatment fluids of the present disclosure may further comprise a buffer. Buffers may be used to maintain a treatment fluid's pH in a limited range. Examples of suitable buffers include, but are not limited to, sodium carbonate, potassium carbonate, sodium bicarbonate, potassium bicarbonate, sodium or potassium diacetate, sodium or potassium phosphate, sodium or potassium hydrogen phosphate, sodium or potassium dihydrogen phosphate, and the like. When used, the buffer may be included in an amount sufficient to maintain the pH of such viscosified treatment fluids at a desired level. In an example, a buffer may be included in an amount of from about 0.5% to about 10% by weight of the treatment fluid. One of ordinary skill in the art, with the benefit of this disclosure, will recognize the appropriate buffer and amount of the buffer to use for a chosen application.

For purposes of this disclosure, the term “essentially neutral pH” generally means that the fluid has a pH that is about 7, but the pH could range from about 6.5 to about 7.5.

Proppants

One component of the fluid treatment systems of the disclosure may include proppants. In some embodiments, the proppants may be an inert material, and may be sized (e.g., a suitable particle size distribution) based upon the characteristics of the void space to be placed in.

Materials suitable for proppant particulates may comprise any material comprising inorganic or plant-based materials suitable for use in subterranean operations. Suitable materials include, but are not limited to, sand; bauxite; ceramic materials; glass materials; nut shell pieces; cured resinous particulates comprising nut shell pieces; seed shell pieces; cured resinous particulates comprising seed shell pieces; fruit pit pieces; cured resinous particulates comprising fruit pit pieces, wood; and any combination thereof. The mean proppant particulate size generally may range from about 2 mesh to about 400 mesh on the U.S. Sieve Series; however, in certain circumstances, other mean proppant particulate sizes may be desired and will be entirely suitable for practice of the embodiments disclosed herein. In particular embodiments, preferred mean proppant particulate size distribution ranges are one or more of 6/12, 8/16, 12/20, 16/30, 20/40, 30/50, 40/60, 40/70, or 50/70 mesh. It should be understood that the term “particulate,” as used herein, includes all known shapes of materials, including substantially spherical materials; fibrous materials; polygonal materials (such as cubic materials); and any combination thereof. In certain embodiments, the particulates may be present in the treatment fluids in an amount in the range of from an upper limit of about 30 pounds per gallon (“ppg”), 25 ppg, 20 ppg, 15 ppg, and 10 ppg (3600, 2400, 1800, 1200 kg/m³) to a lower limit of about 0.5 ppg, 1 ppg, 2 ppg, 4 ppg, 6 ppg, 8 ppg, and 10 ppg (60, 120, 240, 480, 720, 960 kg/m³) by volume of the treatment fluids.

Other Additives

In addition to the foregoing materials, it can also be desirable, in some embodiments, for other components to be present in the treatment fluid. Such additional components can include, without limitation, particulate materials, fibrous materials, bridging agents, weighting agents, gravel, corrosion inhibitors, catalysts, clay control stabilizers, biocides, bactericides, friction reducers, gases, surfactants, solubilizers, salts, scale inhibitors, foaming agents, anti-foaming agents, iron control agents, and the like.

Permeability

Permeability refers to how easily fluids can flow through a material. For example, if the permeability is high, then fluids will flow more easily and more quickly through the material. If the permeability is low, then fluids will flow less easily and more slowly through the material. As used herein, “high permeability” means the material has a permeability of at least 100 milliDarcy (mD). As used herein, “low permeability” means the material has a permeability of less than 1 mD.

Degradability

As used herein, a “degradable” solid material is capable of undergoing an irreversible degradation downhole. The term “irreversible” as used herein means that the degradable material once degraded should not recrystallize or reconsolidate while downhole in the treatment zone, that is, the degradable material should degrade in situ but should not recrystallize or reconsolidate in situ.

The terms “degradable” or “degradation” refer to both the two relatively extreme cases of degradation that the degradable material may undergo, that is, heterogeneous (or bulk erosion) and homogeneous (or surface erosion), and any stage of degradation in between these two. Preferably, the degradable material degrades slowly over time as opposed to instantaneously.

The degradable material is preferably “self-degrading.” As referred to herein, the term “self-degrading” means bridging may be removed without the need to circulate a separate “clean up” solution or “breaker” into the treatment zone, wherein such clean up solution or breaker having no purpose other than to degrade the bridging in the proppant pack. Though “self-degrading,” an operator may nevertheless elect to circulate a separate clean up solution through the well bore and into the treatment zone under certain circumstances, such as when the operator desires to hasten the rate of degradation. In certain embodiments, a degradable material is sufficiently acid-degradable as to be removed by such treatment.

The degradation can be a result of, inter alia, a chemical or thermal reaction or a reaction induced by radiation. The degradable material is preferably selected to degrade by at least one mechanism selected from the group consisting of: hydrolysis, hydration followed by dissolution, dissolution, decomposition, or sublimation.

The choice of degradable material can depend, at least in part, on the conditions of the well, e.g., wellbore temperature. For instance, lactides can be suitable for lower temperature wells, including those within the range of about 60° F. (16° C.) to about 150° F. (66° C.), and polylactides can be suitable for well bore temperatures above this range.

Gels and Viscosity-Increasing Agents

The physical state of a gel is formed by a network of interconnected molecules, such as a crosslinked polymer or a network of micelles. The network gives a gel phase its structure and an apparent yield point. At the molecular level, a gel is a dispersion in which both the network of molecules is continuous and the liquid is continuous. A gel is sometimes considered as a single phase.

Technically, a “gel” is a semi-solid, jelly-like physical state or phase that can have properties ranging from soft and weak to hard and tough. Shearing stresses below a certain finite value fail to produce permanent deformation. The minimum shear stress that will produce permanent deformation is referred to as the shear strength or gel strength of the gel.

In the oil and gas industry, however, the term “gel” may be used to refer to any fluid having a viscosity-increasing agent (i.e., gelling agent), regardless of whether it is a viscous fluid or meets the technical definition for the physical state of a gel. For example, a “base gel” is a term used in the field for a fluid that includes a viscosity-increasing agent, such as guar, but that excludes crosslinking agents. Typically, a base gel is mixed with another fluid containing a crosslinker, wherein the mixture is adapted to form a crosslinked gel. Similarly, a “crosslinked gel” may refer to a substance having a viscosity-increasing agent that is crosslinked, regardless of whether it is a viscous fluid or meets the technical definition for the physical state of a gel.

Certain viscosity-increasing agents can also help suspend a particulate material by increasing the elastic modulus of the fluid. The elastic modulus is the measure of a substance's tendency to be deformed non-permanently when a force is applied to it. The elastic modulus of a fluid, commonly referred to as G′, is a mathematical expression and defined as the slope of a stress versus strain curve in the elastic deformation region. G′ is expressed in units of pressure, for example, Pa (Pascals) or dynes/cm². As a point of reference, the elastic modulus of water is negligible and considered to be zero.

An example of a viscosity-increasing agent that is also capable of increasing the suspending capacity of a fluid is to use a viscoelastic surfactant. As used herein, the term “viscoelastic surfactant” refers to a surfactant that imparts or is capable of imparting viscoelastic behavior to a fluid due, at least in part, to the association of surfactant molecules to form viscosifying micelles.

Viscoelastic surfactants may be cationic, anionic, or amphoteric in nature. The viscoelastic surfactants can comprise any number of different compounds, including methyl ester sulfonates, hydrolyzed keratin, sulfosuccinates, taurates, amine oxides, ethoxylated amides, alkoxylated fatty acids, alkoxylated alcohols (e.g., lauryl alcohol ethoxylate, ethoxylatednonyl phenol), ethoxylated fatty amines, ethoxylated alkyl amines (e.g., cocoalkylamineethoxylate), betaines, modified betaines, alkylamidobetaines (e.g., cocoamidopropyl betaine), quaternary ammonium compounds (e.g., trimethyltallowammonium chloride, trimethylcocoammonium chloride), derivatives thereof, and combinations thereof.

Filter Cakes

Treatment fluids can serve many purposes, including, for example fracturing, lubricating a drill bit, removing cuttings form a wellbore, and providing stability to a well. To accomplish their purposes, treatment fluids possess several characteristics. One common characteristic is the ability to form a coating or “filter cake” on the wall of the wellbore or borehole. The filter cake serves to stabilize the borehole and prevent loss of the liquid portion of the treatment fluid through the walls of the borehole into the adjoining formations. This loss of liquid, commonly referred to as “fluid loss,” is a function of many variables such as the composition of the treatment fluid, the types of formations encountered in the subterranean well, temperatures and pressure in the borehole, etc.

Although a filter cake may be desirable during treatment of a wellbore, removal of the cake is frequently desirable after treatment, as the filter cake may interfere with production of oil and gas from the formation into the well. External breakers are commonly used to assist in removing the filter cake. An external breaker is a breaker that is not included in the treatment fluid, but is applied to the filter cake separately, i.e., it is a breaker that is “external” to the treatment fluid. The treatment fluids of the instant disclosure are unique in that external breakers are not required for removal of the filter cake. Instead, according to certain examples, the treatment fluid of the present disclosure uses no breakers or internal breakers.

Methods of Use

A self-suspending diverter materials of the type disclosed herein may be included in any suitable wellbore servicing fluid. As used herein, a “servicing fluid” refers to a fluid used to drill, complete, work over, fracture, repair, or in any way prepare a wellbore for the recovery of materials residing in a subterranean formation penetrated by the wellbore. Examples of wellbore servicing fluids include, but are not limited to, cement slurries, drilling fluids or muds, spacer fluids, lost circulation fluids, fracturing fluids, diverting fluids or completion fluids. The servicing fluid is for use in a wellbore that penetrates a subterranean formation. It is to be understood that “subterranean formation” encompasses both areas below exposed earth and areas below earth covered by water such as ocean or fresh water.

A method of servicing a wellbore may comprise placing a wellbore servicing fluid (e.g., fracturing or other stimulation fluid such as an acidizing fluid) into a portion of a wellbore. In such embodiments, the fracturing or stimulation fluid may enter flow paths and perform its intended function of increasing the production of a desired resource from that portion of the wellbore. The level of production from the portion of the wellbore that has been stimulated may taper off over time such that stimulation of a different portion of the well is desirable. Additionally or alternatively, previously formed flowpaths may need to be temporarily plugged in order to fracture or stimulate additional/alternative intervals or zones during a given wellbore service or treatment. In an embodiment, an amount of a diverting fluid (e.g., wellbore servicing fluid comprising a self-suspending diverter material) sufficient to effect diversion of a wellbore servicing fluid from a first flowpath to a second flowpath is delivered to the wellbore. The diverting fluid may form a temporary plug, also known as a diverter plug or diverter cake, once disposed within the first flowpath which restricts entry of a wellbore servicing fluid (e.g., fracturing or stimulation fluid) into the first flowpath. The diverter plug deposits onto the face of the formation and creates a temporary skin or structural, physical and/or chemical obstruction that decreases the permeability of the zone. The wellbore servicing fluid restricted from entering the first flowpath may enter one or more additional flowpaths and perform its intended function. Within a first treatment stage, the process of introducing a wellbore servicing fluid into the formation to perform an intended function (e.g., fracturing or stimulation) and, thereafter, diverting the wellbore servicing fluid to another flowpath into the formation and/or to a different location or depth within a given flowpath may be continued until some user and/or process goal is obtained. In an additional embodiment, this diverting procedure may be repeated with respect to each of a second, third, fourth, fifth, sixth, or more, treatment stages, for example, as disclosed herein with respect to the first treatment stage.

In an embodiment, the wellbore service being performed is a fracturing operation, wherein a fracturing fluid is placed (e.g., pumped downhole) at a first location in the formation and self-suspending diverter material is employed to divert the fracturing fluid from the first location to a second location in the formation such that fracturing can be carried out at a plurality of locations. The self-suspending diverter material may be placed into the first (or any subsequent location) via pumping a slug of a diverter fluid (e.g., a fluid having a different composition than the fracturing fluid) containing the self-suspending diverter material and/or by adding the self-suspending diverter material directly to the fracturing fluid, for example to create a slug of fracturing fluid comprising the self-suspending diverter material. The self-suspending diverter material may form a diverter plug at the first location (and any subsequent location so treated) such that the fracturing fluid may be selectively placed at one or more additional locations, for example during a multi-stage fracturing operation.

In an embodiment, following a wellbore servicing operation utilizing a diverting fluid (e.g., a wellbore servicing fluid comprising a self-suspending diverter material), the wellbore and/or the subterranean formation may be prepared for production, for example, production of a hydrocarbon, therefrom.

In an embodiment, preparing the wellbore and/or formation for production may comprise removing a self-suspending diverter material (which has formed a temporary plug) from one or more flowpaths, for example, by allowing the diverting materials therein to degrade and subsequently recovering hydrocarbons from the formation via the wellbore.

In an embodiment, the self-suspending diverter material when subjected to degradation conditions of the type disclosed herein (e.g., elevated temperatures and/or pressures) degrades in a time range of about 4 hours, alternatively about 6 hours, or alternatively about 12 hours. Alternatively, self-suspending diverter materials of the type disclosed herein substantially degrade in a time frame of less than about 1 week, alternatively less than about 2 days, or alternatively less than about 1 day.

In another embodiment, the self-suspending diverter materials comprise a material which is characterized by the ability to be degraded at bottom hole temperatures (BHT) of less than about 120° F. (49° C.), alternatively less than about 250° F. (121° C.), or alternatively less than about 350° F. (177° C.).

In an embodiment, the self-suspending diverter materials and aqueous base fluid are manufactured and then contacted together at the well site, forming the self-suspending diverter material fluid as previously described herein. Alternatively, the self-suspending diverter material and aqueous base fluid are manufactured and then contacted together either off-site or on-the-fly (e.g., in real time or on-location), forming the diverter fluids as previously described herein.

Alternatively, the self-suspending diverter material may be assembled and prepared as a slurry in the form of a liquid additive. In an embodiment, the self-suspending diverter material fluid and a wellbore servicing fluid may be blended until the self-suspending diverter material particulates are distributed throughout the fluid. By way of example, the self-suspending diverter material particulates and a wellbore servicing fluid may be blended using a blender, a mixer, a stirrer, a jet mixing system, or other suitable device. In an embodiment, a recirculation system keeps the self-suspending diverter material particulates uniformly distributed throughout the wellbore servicing fluid (e.g., a concentrated solution or slurry).

When it is desirable to prepare a wellbore servicing fluid comprising an self-suspending diverter material of the type disclosed herein (i.e., a diverting fluid) for use in a wellbore, the diverting fluid prepared at the wellsite or previously transported to and, if necessary, stored at the on-site location may be combined with the self-suspending diverter material, additional water and optional other additives to form the diverting fluid. In an embodiment, additional diverting materials may be added to the diverting fluid on-the-fly along with the other components/additives. The resulting diverting fluid may be pumped downhole where it may function as intended.

In an embodiment, a concentrated self-suspending diverter material liquid additive is mixed with additional water to form a diluted liquid additive, which is subsequently added to a diverting fluid. The additional water may comprise fresh water, salt water such as an unsaturated aqueous salt solution or a saturated aqueous salt solution, or combinations thereof. In an embodiment, the liquid additive comprising the self-suspending diverter material is injected into a delivery pump being used to supply the additional water to a diverting fluid composition. As such, the water used to carry the self-suspending diverter material particulates and this additional water are both available to the diverting fluid such that the self-suspending diverter material may be dispersed throughout the diverting fluid.

In an alternative embodiment, the self-suspending diverter material is prepared as a liquid additive is combined with a ready-to-use diverting fluid as the diverting fluid is being pumped into the wellbore. In such embodiments, the liquid additive may be injected into the suction of the pump. In such embodiments, the liquid additive can be added at a controlled rate to the diverting fluid (e.g., or a component thereof such as blending water) using a continuous metering system (CMS) unit. The CMS unit can also be employed to control the rate at which the liquid additive is introduced to the diverting fluid or component thereof as well as the rate at which any other optional additives are introduced to the diverting fluid or component thereof. As such, the CMS unit can be used to achieve an accurate and precise ratio of water to self-suspending diverter material concentration in the diverting fluid such that the properties of the diverting fluid (e.g., density, viscosity), are suitable for the downhole conditions of the wellbore. The concentrations of the components in the diverting fluid, e.g., the self-suspending diverter materials, can be adjusted to their desired amounts before delivering the composition into the wellbore. Those concentrations thus are not limited to the original design specification of the diverting fluid and can be varied to account for changes in the downhole conditions of the wellbore that may occur before the composition is actually pumped into the wellbore.

Wellbore and Formation

Broadly, a zone refers to an interval of rock along a wellbore that is differentiated from surrounding rocks based on hydrocarbon content or other features, such as perforations or other fluid communication with the wellbore, faults, or fractures. A treatment usually involves introducing a treatment fluid into a well. As used herein, a treatment fluid is a fluid used in a treatment. Unless the context otherwise requires, the word treatment in the term “treatment fluid” does not necessarily imply any particular treatment or action by the fluid. If a treatment fluid is to be used in a relatively small volume, for example less than about 200 barrels (24 m³), it is sometimes referred to in the art as a slug or pill. As used herein, a treatment zone refers to an interval of rock along a wellbore into which a treatment fluid is directed to flow from the wellbore. Further, as used herein, into a treatment zone means into and through the wellhead and, additionally, through the wellbore and into the treatment zone. The near-wellbore region of a zone is usually considered to include the matrix of the rock within a few inches of the borehole. As used herein, the near-wellbore region of a zone is considered to be anywhere within about 12 inches (30 cm) of the wellbore. The far-field region of a zone is usually considered the matrix of the rock that is beyond the near-wellbore region.

As used herein, into a subterranean formation can include introducing at least into and/or through a wellbore in the subterranean formation. According to various techniques known in the art, equipment, tools, or well fluids can be directed from a wellhead into any desired portion of the wellbore. Additionally, a well fluid can be directed from a portion of the wellbore into the rock matrix of a zone.

In various embodiments, systems configured for delivering the treatment fluids described herein to a downhole location are described. In various embodiments, the systems can comprise a pump fluidly coupled to a tubular, the tubular containing the polymerizable aqueous consolidation compositions and/or the water-soluble polymerization initiator compositions, and any additional additives, disclosed herein.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluid to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi (69 bar) or less. In some embodiments, a low pressure pump may be fluidly coupled to a high pressure pump that is fluidly coupled to the tubular. That is, in such embodiments, the low pressure pump may be configured to convey the treatment fluid to the high pressure pump. In such embodiments, the low pressure pump may “step up” the pressure of the treatment fluid before it reaches the high pressure pump.

In some embodiments, the systems described herein can further comprise a mixing tank that is upstream of the pump and in which the treatment fluid is formulated. In various embodiments, the pump (e.g., a low pressure pump, a high pressure pump, or a combination thereof) may convey the treatment fluid from the mixing tank or other source of the treatment fluid to the tubular. In other embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole.

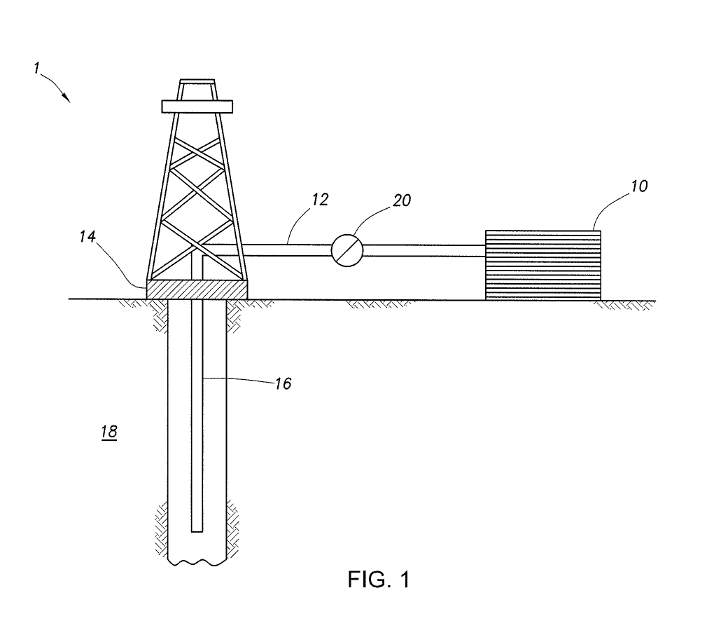

FIG. 1 shows an illustrative schematic of a system that can deliver treatment fluids of the embodiments disclosed herein to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which a treatment fluid of the embodiments disclosed herein may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

The invention having been generally described, the following examples are given as particular embodiments of the invention and to demonstrate the practice and advantages hereof. It is understood that the examples are given by way of illustration and are not intended to limit the specification or the claims to follow in any manner.

### Examples

1. Static HPHT Fluid Loss Using
   a. ceramic disc—With psyllium husk particulates
   b. slotted stainless steel (SS) disc—with mixture of psyllium husk and BARACARB-150™ bridging agent particulates
   c. slotted stainless steel (SS) disc—with BARACARB-150™ bridging agent particulates (Control test)
2. Degradation study of psyllium husk particulates in HCl
3. Degradation study of psyllium husk particulates in neutral medium

The selection of size of ceramic disc for the static HPHT fluid loss analysis was done based on Particle Size Distribution (PSD) tests on particles utilizing a MASTERSIZER-2000™ device.

Another characteristic of a good diverter/fluid loss controlling agent is its self-degradability under downhole conditions. Degradation studies with 15% and 25% HCl were also conducted to prove the effectiveness of this material in terms self-degradation.

The results of both these tests are captured in the section below.

### 1. Static HPHT Fluid Loss Study of Psyllium Husk Particulates:

a) HPHT Fluid Loss Test with Ceramic Disc

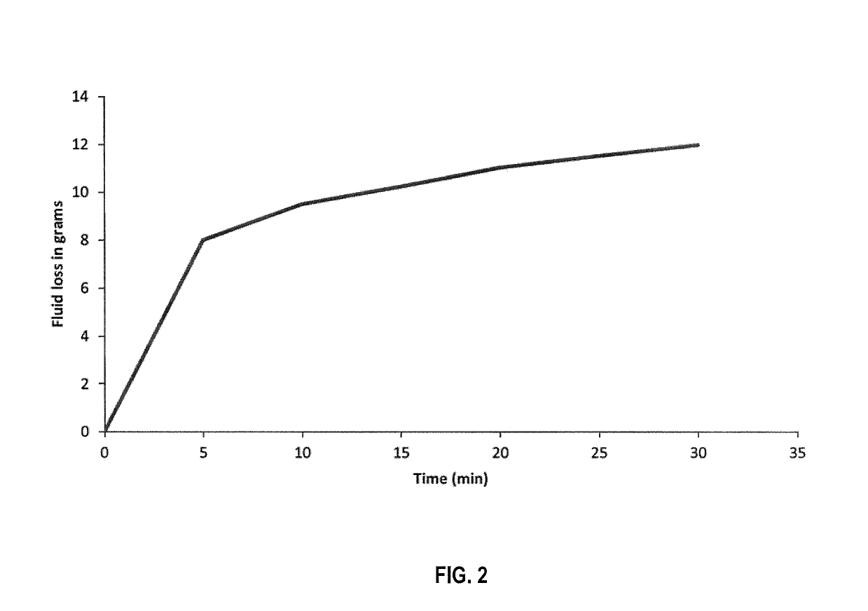

To prepare the fluid for HPHT fluid loss test 400 mL of 3% KCl brine solution was prepared. To that 10 g (i.e. 2.5%) of psyllium husk particulates were added. The gel was hydrated for 30 min. in a Waring blender. After the complete hydration a viscous gel was formed. This gel was loaded in an HPHT cell to perform a static fluid loss test. The test was done at 180° F. (82° C.) and at a differential pressure of 500 psi (34 bar) using a 90 micron ceramic disc. Total fluid loss obtained after 30 minutes was 12 g. FIG. 2 is a graph of the fluid loss over time.

The HPHT tests results show that psyllium husk particulates are capable of forming a low permeability filter cake on a 90 micron ceramic disc. This confirms the excellent filter cake forming capability of psyllium husk particulates.

b) HPHT Fluid Loss Test with 200 Micron Slotted Stainless Steel Disc

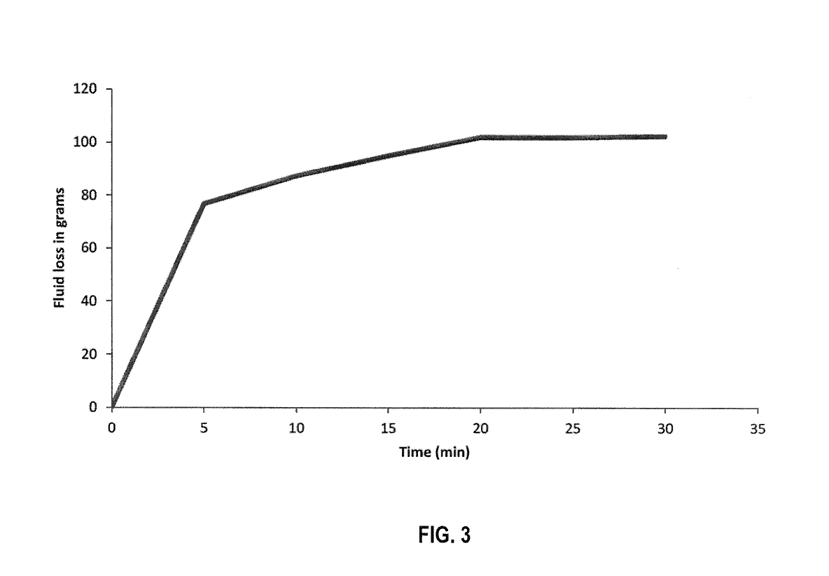

To prepare the fluid for HPHT fluid loss test 400 mL of 3% brine solution was prepared. To that 10 g (i.e. 2.5%) of psyllium husk particulates and 20 g of BARACARB-150™ bridging agent (i.e. 5%) were added. The gel was hydrated for 30 min. in a Waring blender. After the complete hydration a viscous gel was formed. This gel was loaded in an HPHT cell to perform a static fluid loss test. The test was done at 180° F. (82° C.) and at a differential pressure of 200 psi (14 bar) on a 200 microns slotted stainless steel disc. Total fluid loss obtained after 30 minutes was 102 g. BARACARB-150™ is a bridging agent available from Halliburton Energy Services, Inc., Houston, Tex. FIG. 3 is a graph of the fluid loss over time.

The HPHT tests results show that psyllium husk particulates along with BARACARB-150™ bridging agent form an essentially impermeable filter cake on a 200 micron slotted stainless steel disc.

c) Control HPHT Fluid Loss Test with BARACARB-150™ Particulates Using 200 Micron Slotted Stainless Steel Disc

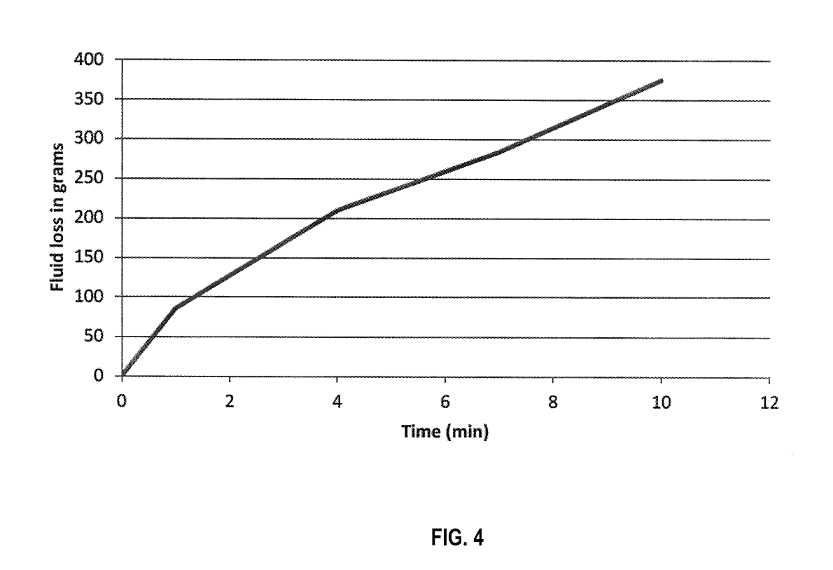

To prepare the fluid for this test 400 mL of 3% brine solution was prepared. To that 20 g of BARACARB-150™ bridging agent (i.e. 5 wt %) was added. The mixture was stirred in a Waring blender. This fluid was loaded in an HPHT cell to perform a static fluid loss test. The test was done at 180° F. (82° C.) and at a differential pressure of 200 psi (14 bar) using a 200 micron slotted stainless steel disc. Fluid loss obtained after 10 minutes of testing was approximately 375 g. FIG. 4 is a graph of the fluid loss over time.

Based on the slope of the curve and the volume of fluid lost, as compared to the previous tests, the filter-cake formed by BARACARB-150™ bridging agent particulates was much more permeable and failed to provide acceptable fluid loss control.

### 2. Degradation Study of Psyllium Husk Particulates in HCl

The acid stability of psyllium particulates was evaluated by adding 5 gm of particulates to 15 and 25% HCl for a period of 6 hours @ 180° F. (82° C.). The amount of residue left after the pre-decided time was calculated by filtering the acid solution. The result showed that 97% of the particulates were degraded in 6 hours with 25% HCl (Table 1).

TABLE 1
Degradation study of psyllium husk particulates

| HCL | | Weight (Residue) | % Degradation |
|---|---|---|---|
| concentration | Initial weight | after 6 hours | after 6 hours |
| 15% | 5.00 g | 0.96 g | 81% |
| 25% | 5.00 g | 0.15 g | 97% |

A Gooch crucible was used for filtering the residue from the psyllium husk after degradation. The very low amount of residue left on the Gooch crucible demonstrates that using these particulates will not damage the formation permeability and hence may be effectively used for an acid diversion application.

### 3. Degradation Study of Psyllium Husk Particulates in Neutral Medium

In order to envision degradation/cleanup properties of psyllium husk particulates, degradation of study of psyllium husk was performed in a neutral (non-acid) environment. A typical breaker such as SP BREAKER™ additive or HT BREAKER™ additive was used to conduct a degradation study in a neutral medium. SP BREAKER™ additive and HT BREAKER™ additive are both available from Halliburton Energy Services, Inc., Houston, Tex.

For this study, highly viscous gel (200 lb/Mgal) (24 kg/m³) was prepared by adding 7.2 g psyllium husk particulates in 300 mL of 3% KCl brine. The mixture was stirred in Warring blender for 1 minute and hydrated for 1 hour resulting in a very viscous thick gel.

Break Test on Fann 35

100 mL of the psyllium husk gel was placed in a Warring blender, 0.01 mL (0.1 gpt) of the HT BREAKER™ additive was added to it while stirring. This gel was kept in a preheated water bath at 180° F. (82° C.) for 5 hours. A clear broken fluid was observed after the test duration. The Fann-35 dial readings for the broken fluid are given in Table 2.

TABLE 2
Fann-35 apparent viscosities (dial readings)
for gel after hydration and after break

Apparent viscosity (cP)

| RPM | Before breaking | After breaking |
|---|---|---|
| 3 | 35 | 3 |
| 6 | 42 | 4 |
| 100 | 155 | 5 |
| 200 | 225 | 7 |
| 300 | 300+ | 9 |
| 600 | 300+ | 10 |

Degradation Study in Static Condition:

200 lb/Mgal (24 kg/m³) of the psyllium husk gel was prepared by adding 7.2 g of the husk to 300 mL of 3% KCl brine. After complete hydration, 0.015 mL (0.05 gpt) of HT BREAKER™ additive was added. This solution was kept in a water bath at 180° F. overnight. The broken gel was filtered through a pre-weighed Gooch crucible and dried in oven at 80° C. Table 3 shows the results of the study.

TABLE 3
Degradation study of psyllium husk particulates in neutral medium

| | Weight (Residue) | % Degradation |
|---|---|---|
| Initial weight | after degradation | after 6 hours |
| 1.0 g | 0.12 g | 88 |

From the above test results one of skill in the art will conclude that psyllium husk particulates may be an effective choice for diverting/fluid loss control agents in fracturing and acidizing applications and may replace existing systems.

Embodiments disclosed herein include:

A: A method of servicing a wellbore in a subterranean formation comprising: combining diverter material and aqueous base fluid to form a diverter fluid, wherein the diverter material is self-suspending and comprises psyllium husk particulates; introducing the diverter fluid into the wellbore; and allowing the diverter material to form a diverter plug in the wellbore or the formation.

B: A method of servicing a wellbore in a subterranean formation comprising: combining diverter material and a first wellbore servicing fluid, wherein the diverter material is self-suspending and comprises psyllium husk particulates and the first wellbore servicing fluid comprises an aqueous base fluid; introducing the first wellbore servicing fluid into the wellbore; allowing the diverter material to form a diverter plug in a first location in the wellbore or the formation; diverting the flow of a second wellbore servicing fluid to a second location in the wellbore of formation; and removing the diverter plug, wherein the first and second wellbore servicing fluids may be the same or different.

C: A method of servicing a wellbore in a subterranean formation comprising: placing a wellbore fluid into a subterranean formation at a first location; plugging the first location with a self-suspending diverter material comprising psyllium husk particulates, wherein all or a portion of the wellbore servicing fluid is diverted to a second location in the subterranean formation; placing the wellbore servicing fluid into the subterranean formation at the second location; and allowing the diverter material to degrade to provide a flowpath from the subterranean formation to the wellbore for recovery of resources from the subterranean formation.

D: A wellbore treatment fluid comprising: a diverter material and an aqueous base fluid, wherein the diverter material is self-suspending and comprises psyllium husk particulates.

E: A well treatment system comprising: a well treatment apparatus, including a mixer and a pump, configured to: combine diverter material and aqueous base fluid to form a diverter fluid, wherein the diverter material is self-suspending and comprises psyllium husk particulates; introduce the diverter fluid into the wellbore; and allow the diverter material to form a diverter plug in the wellbore or the formation.

Each of embodiments A, B, C, D, and E may have one or more of the following additional elements in any combination: Element 1: further comprising allowing the diverter material to degrade to provide a pathway from the formation to the wellbore for recovery of resources from the subterranean formation. Element 2: wherein the degrading does not include breakers. Element 3: wherein the method does not comprise using a gelling agent. Element 4: wherein the combining further comprises adding an internal breaker. Element 5: wherein the internal breaker comprises at least one breaker selected from the group consisting of an acid, an oxidizer, an enzyme, and combinations thereof. Element 6: wherein the degrading occurs in the wellbore or formation with an essentially neutral pH. Element 7: wherein the diverter material degrades at least about 50% within 6 hours at about 180° F. (82° C.). Element 8: wherein the combining further comprises adding a bridging agent. Element 9: wherein the diverter material is present in the diverter fluid in the amount of from about 40 ppt (4.8 kg/m³) to about 80 ppt (9.6 kg/m³) by volume of diverter fluid. Element 10: wherein the plugging includes a diverter material in the wellbore servicing fluid in the amount of from about 40 ppt (4.8 kg/m³) to about 80 ppt (9.6 kg/m³) by volume of diverter fluid. Element 11: wherein no breakers are present. Element 12: wherein the fluid does not comprise a gelling agent. Element 13: wherein the fluid further comprises an internal breaker. Element 14: wherein the diverter material further comprises a bridging agent.

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

1. A method of servicing a wellbore in a subterranean formation comprising:
combining diverter material and aqueous base fluid to form a diverter fluid, wherein the diverter material is self-suspending and comprises psyllium husk particulates;
introducing the diverter fluid into the wellbore; and
allowing the diverter material to form a diverter plug in the wellbore or the formation.

2. The method of claim 1, further comprising allowing the diverter material to degrade to provide a pathway from the formation to the wellbore for recovery of resources from the subterranean formation.

3. The method of claim 2, wherein the degrading does not include breakers.

4. The method of claim 1, wherein the method does not comprise using a gelling agent.

5. The method of claim 1, wherein the combining further comprises adding an internal breaker.

6. The method of claim 5, wherein the internal breaker comprises at least one breaker selected from the group consisting of an acid, an oxidizer, an enzyme, and combinations thereof.

7. The method of claim 5, wherein the degrading occurs in the wellbore or formation with an essentially neutral pH.

8. The method of claim 7, wherein the diverter material degrades at least about 50% within 6 hours at about 180° F. (82° C.).

9. The method of claim 1, wherein the combining further comprises adding a bridging agent.

10. The method of claim 1, wherein the diverter material is present in the diverter fluid in the amount of from about 40 ppt (4.8 kg/m³) to about 80 ppt (9.6 kg/m³) by volume of diverter fluid.

11. A method of servicing a wellbore in a subterranean formation comprising:
combining diverter material and a first wellbore servicing fluid, wherein the diverter material is self-suspending and comprises psyllium husk particulates and the first wellbore servicing fluid comprises an aqueous base fluid;
introducing the first wellbore servicing fluid into the wellbore;
allowing the diverter material to form a diverter plug in a first location in the wellbore or the formation;
diverting the flow of a second wellbore servicing fluid to a second location in the wellbore of formation; and
removing the diverter plug, wherein the first and second wellbore servicing fluids may be the same or different.

12. The method of claim 11, wherein the removing does not include breakers.

13. The method of claim 11, wherein the diverter material and first wellbore servicing fluid do not comprise a gelling agent.

14. The method of claim 11, wherein the combining further comprises adding an internal breaker.

15. The method of claim 11, wherein the internal breaker comprises at least one breaker selected from the group consisting of an acid, an oxidizer, an enzyme, and combinations thereof.

16. The method of claim 14, further comprising an internal breaker, wherein the removing comprises degrading and occurs in the wellbore or formation with an essentially neutral pH.

17. The method of claim 16, wherein the diverter material degrades at least about 50% within 6 hours at about 180° F. (82° C.).

18. The method of claim 11, wherein the combining further comprises adding a bridging agent.

19. The method of claim 11, wherein the diverter material is present in the first wellbore servicing fluid in the amount of from about 40 ppt (4.8 kg/m³) to about 80 ppt (9.6 kg/m³) by volume of diverter fluid.

20. The method of claim 11, wherein the first wellbore servicing fluid comprises a diverting fluid and the second wellbore servicing fluid comprises a fracturing fluid.

21. A method of servicing a wellbore in a subterranean formation comprising:
placing a wellbore fluid into a subterranean formation at a first location;
plugging the first location with a self-suspending diverter material comprising psyllium husk particulates, wherein all or a portion of the wellbore servicing fluid is diverted to a second location in the subterranean formation;
placing the wellbore servicing fluid into the subterranean formation at the second location; and
allowing the diverter material to degrade to provide a flowpath from the subterranean formation to the wellbore for recovery of resources from the subterranean formation.

22. The method of claim 21, wherein the method does not comprise using a gelling agent.

23. The method of claim 21, wherein the diverter material further comprises an internal breaker.

24. The method of claim 23, wherein the internal breaker comprises at least one breaker selected from the group consisting of an acid, an oxidizer, an enzyme, and combinations thereof.

25. The method of claim 21, wherein the diverter material further comprises a bridging agent.

26. The method of claim 21, wherein the plugging includes a diverter material in the wellbore servicing fluid in the amount of from about 40 ppt (4.8 kg/m³) to about 80 ppt (9.6 kg/m³) by volume of diverter fluid.

27. A wellbore treatment fluid comprising:
a diverter material and an aqueous base fluid, wherein the diverter material is self-suspending and comprises psyllium husk particulates.

28. The fluid of claim 27, wherein no breakers are present.

29. The fluid of claim 27, wherein the fluid does not comprise a gelling agent.

30. The fluid of claim 27, wherein the fluid further comprises an internal breaker.

31. The fluid of claim 27, wherein the diverter material further comprises a bridging agent.

32. A well treatment system comprising:
a well treatment apparatus, including a mixer and a pump, configured to:
combine diverter material and aqueous base fluid to form a diverter fluid, wherein the diverter material is self-suspending and comprises psyllium husk particulates;
introduce the diverter fluid into the wellbore; and
allow the diverter material to form a diverter plug in the wellbore or the formation.
